(19) United States
(12) Patent Application Publication
(10) Pub. No.: US 2006/0059520 A1
(43) Pub. Date: Mar. 16, 2006

(54) Recorded program searching apparatus and recorded program searching method

(75) Inventor: Akira Miyazawa, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/219,906

(22) Filed: Sep. 7, 2005

(30) Foreign Application Priority Data
Sep. 13, 2004 (JP) 2004-265814

(51) Int. Cl. H04N 5/445; G06F 13/00; G06F 3/00

(52) U.S. Cl. 725/52; 725/53; 725/39

(57) ABSTRACT

There are provided connection units configured to connect a plurality of recording units, a selection unit configured to select a predetermined recording unit from the plurality of recording units connected to the connection units, a setting unit configured to set a plurality of types of searching conditions for searching a recorded program from the recording unit selected at the selection unit, and a searching unit configured to carry out a program search on the basis of the plurality of types of searching conditions set at the setting unit from among programs recorded in the recording unit selected at the selection unit.

### CROSS-REFERENCE TO RELATED APPLICATIONS

This application is based upon and claims the benefit of priority from prior Japanese Patent Application No. 2004-265814, filed Sep. 13, 2004, the entire contents of which are incorporated herein by reference.

### BACKGROUND OF THE INVENTION

1. Field of the Invention

The present invention relates to a recorded program searching apparatus and a recorded program searching method which are suitable for being used for, for example, a digital television broadcasting receiver or the like.

2. Description of the Related Art

As is well known, in recent years, digitization of television broadcasting has been advanced. For example, in Japan, not only satellite digital broad-casting such as broadcasting satellite (BS) digital broadcasting, or 110 communication satellite (CS) digital broadcasting, but also terrestrial digital broadcasting has been started.

Then, in such a digital broadcasting receiver which receives digital television broadcasting, it is possible to digitally record a received program and to play back a recorded program by connecting a digital recording device having a large capacity such as, for example, a hard disk drive (HDD).

Moreover, currently, by networking with a plurality of digital recording devices being connected to one digital broadcasting receiver, the digital broadcasting receiver can designate an arbitrary digital recording device to carry out recording a program, and can designate an arbitrary digital recording device to carry out playback a program.

By the way, in a digital broadcasting receiver which enables a plurality of digital recording devices to be connected to a network, it is important that a user can easily manage programs recorded in the respective digital recording devices, and can rapidly search and play back a desired recorded program.

In Jpn. Pat. Appln. KOKAI Publication No. 2002-352558, there is disclosed a technology in which it is possible to rapidly and flexibly search an objective program from a recording medium on which many programs have been recorded with a function of making a search on the basis of additional information on a recorded program.

Further, in Jpn. Pat. Appln. KOKAI Publication No. 2000-285647, there is disclosed a technology in which it is rapidly and efficiently search image data which has been recorded by a reservation by registering genres such as “Documentary program”, “Drama” and “Movie” of programs which have been recorded by a reservation as items in a directory.

Moreover, in Jpn. Pat. Appln. KOKAI Publication No. 2000-182359, there is disclosed a technology in which, because mandatory text data for selecting video data are expressed in alphanumeric characters even when there are various languages of text data at the time of playing-back, a program or a cell to be played back can be selected independently of a language, and moreover, it is possible to carry out a search for text information with the same language code as that of an apparatus.

### BRIEF SUMMARY OF THE INVENTION

According to one aspect of the present invention, there is provided a recorded program searching apparatus comprising: connection units configured to connect to a plurality of recording units; a selection unit configured to select a predetermined recording unit from the plurality of recording units connected to the connection units; a setting unit configured to set a plurality of types of searching conditions for searching a recorded program from the recording unit selected at the selection unit; and a searching unit configured to carry out a program search on the basis of the plurality of types of searching conditions set at the setting unit from among programs recorded in the recording unit selected at the selection unit.

According to another aspect of the present invention, there is provided a recorded program searching method comprising: a first step of connecting a plurality of recording units; a second step of selecting a predetermined recording unit from the plurality of recording units connected in the first step; a third step of setting a plurality of types of searching conditions for searching a recorded program from the recording unit selected in the second step; and a fourth step of carrying out a program search on the basis of the plurality of types of searching conditions set in the third step from the recording unit selected in the second step.

### BRIEF DESCRIPTION OF THE SEVERAL VIEWS OF THE DRAWING

FIG. 1 is a diagram showing one embodiment of the present invention, and schematic explaining one example of a digital television broadcasting receiver and a network system configured so as to center on the apparatus;

FIG. 2 is a block diagram for explaining a main signal processing system of the digital television broadcasting receiver in the embodiment;

FIG. 3 is an external view for explaining a remote controller of the digital television broadcasting receiver in the embodiment;

FIG. 4 is a flowchart for explaining operations for setting a program designating reservation in the digital television broadcasting receiver in the embodiment;

FIGS. 5A to 5C are respectively views for explaining one example of various setting screens at the time of setting a program designating reservation in the digital television broadcasting receiver in the embodiment;

FIG. 6 is a flowchart for explaining operations for setting a date and time designating reservation in the digital television broadcasting receiver in the embodiment;

FIGS. 7A to 7D are respectively views for explaining one example of various setting screens at the time of setting a date and time designating reservation in the digital television broadcasting receiver in the embodiment;

FIG. 8 is a flowchart for explaining operations for recording a viewing program of the digital television broadcasting receiver in the embodiment;

FIG. 9 is a view for explaining one example of a recording setting screen for causing the digital television broadcasting receiver in the embodiment to carry out operations for recording a viewing program;

FIG. 10 is a flowchart for explaining operations after executing recording of the digital television broadcasting receiver in the embodiment has been executed;

FIG. 11 is a view for explaining one example of an output setting screen of the digital television broadcasting receiver in the embodiment;

FIG. 12 is a flowchart for explaining operations for reserved recording in which outputs have been set of the digital television broadcasting receiver in the embodiment;

FIG. 13 is a flowchart for explaining operations for recording a viewing program in which outputs have been set of the digital television broadcasting receiver in the embodiment;

FIG. 14 is a flowchart for explaining operations for searching a recorded program of the digital television broadcasting receiver in the embodiment;

FIG. 15 is a view for explaining one example of a navigation screen of operations for searching a recorded program in the embodiment;

FIG. 16 is a view for explaining one example of a device selection screen of operations for searching a recorded program in the embodiment;

FIG. 17 is a view for explaining one example of a library screen of operations for searching a recorded program in the embodiment;

FIG. 18 is a view for explaining one example of a recorded program searching screen for operations for searching a recorded program in the embodiment;

FIG. 19 is a view for explaining one example of a genre setting screen of operations for searching a recorded program in the embodiment;

FIG. 20 is a view for explaining one example of a keyword setting screen of operations for searching a recorded program in the embodiment;

FIG. 21 is a view for explaining one example of a date setting screen of operations for searching a recorded program in the embodiment;

FIG. 22 is a view for explaining one example of a channel setting screen of operations for searching a recorded program in the embodiment;

FIG. 23 is a view for explaining one example of a searching place setting screen of operations for searching a recorded program in the embodiment;

FIG. 24 is a view for explaining one example of a screen of a recorded program searching result of operations for searching a recorded program in the embodiment; and

FIG. 25 is a flowchart for explaining operations for playing back a program selected from a screen of a recorded program searching result in the embodiment.

### DETAILED DESCRIPTION OF THE INVENTION

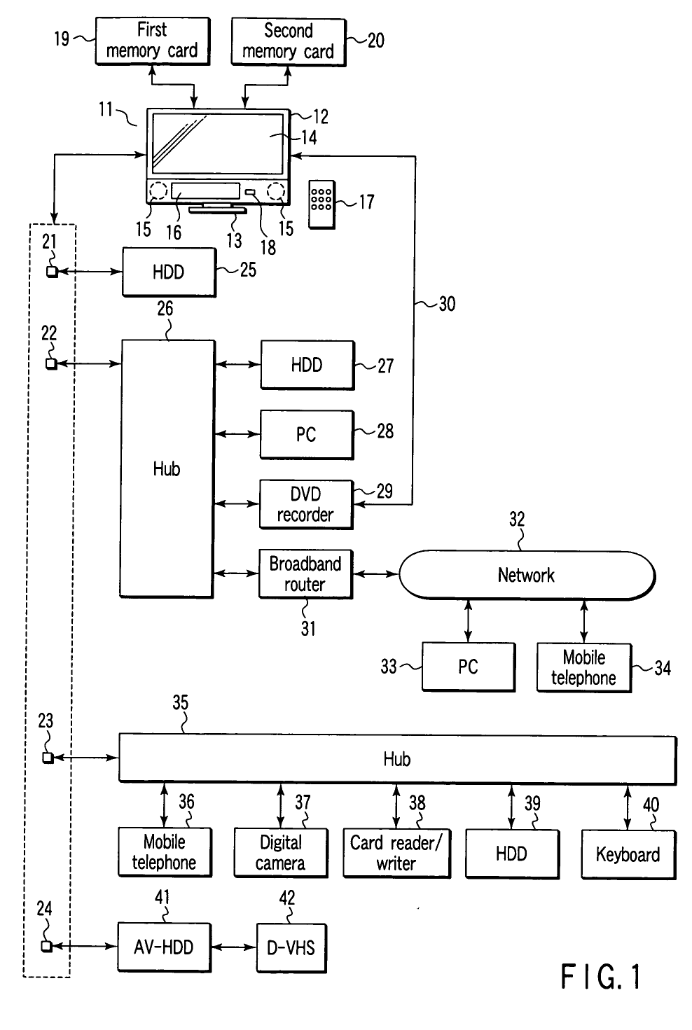

Hereinafter, an embodiment of the present invention will be described in detail with reference to the drawings. FIG. 1 schematically shows an appearance of a digital television broadcasting receiver 11 which will be described in this embodiment, and one example of a network system configured so as to center on the digital television broadcasting receiver 11.

Namely, the digital television broadcasting receiver 11 is mainly configured of a flat type cabinet 12 and a supporting table 13 which stands up the cabinet 12 to be supported. Then, a flat panel type image display 14 composed of, for example, a crystal display panel or the like, speakers 15, an operating unit 16, an optical receiver unit 18 for receiving operational information transmitted from a remote controller 17, and the like are provided to the cabinet 12.

Further, a first memory card 19 such as a secure digital (SD) memory card, a multimedia card (MMC) or a memory stick can be attached to and detached from the digital television broadcasting receiver 11, and information on programs and photographs is recorded in and played back from the first memory card 19.

Moreover, a second memory card (IC card) 20 on which, for example, contract information and the like have been recorded can be attached to and detached from the digital television broadcasting receiver 11, and information is recorded in and played back from the second memory card 20.

Further, the digital television broadcasting receiver 11 has a first local area network (LAN) terminal 21, a second LAN terminal 22, a universal serial bus (USB) terminal 23, and an i.Link terminal 24.

Among those, the first LAN terminal 21 is used as a LAN compatible HDD dedicated port, and is used for carrying out recording and playback of information by Ethernet (registered trademark) with respect to a LAN compatible HDD 25 which is a network attached storage (NAS) connected to the first LAN terminal 21.

In this way, the first LAN terminal 21 serving as a LAN compatible HDD dedicated port is provided, whereby information on programs in Hi-vision quality can be stably recorded in the HDD 25 without being influenced by other network environments, network statuses of use, and the like.

Further, the second LAN terminal 22 is used as a general LAN compatible port using Ethernet, and for example, a LAN compatible HDD 27, a personal computer (PC) 28, a digital versatile disk (DVD) recorder 29 with a built-in HDD, and the like are connected to the second LAN terminal 22 via a hub 26, and the second LAN terminal 22 is used for carrying out information transmission with those devices.

Note that, with respect to the DVD recorder 29, digital information communicated via the second LAN terminal 22 are only control system information, and therefore, it is necessary to provide a dedicated analog transmission path 30 in order to transmit analog image and audio information with the digital television broadcasting receiver 11.

Moreover, the second LAN terminal 22 is connected to a network 32 such as, for example, Internet via a broadband router 31 connected to the hub 26, and is used for carrying out information transmission with a PC 33, a mobile telephone 34, or the like via the network 32.

Further, the USB terminal 23 is used as a general USB type port, and USB devices such as, for example, a mobile telephone 36, a digital camera 37, a card reader/writer 38 for a memory card, an HDD 39, and a keyboard 40 are connected thereto via a hub 35, and the USB terminal 23 is used for carrying out information transmission with those USB devices.

Moreover, for example, an AV-HDD 41, a D (digital)-VHS (video home system) 42, and the like are connected in serial to the i.Link terminal 24, and the i.Link terminal 24 is used for carrying out information transmission with those devices.

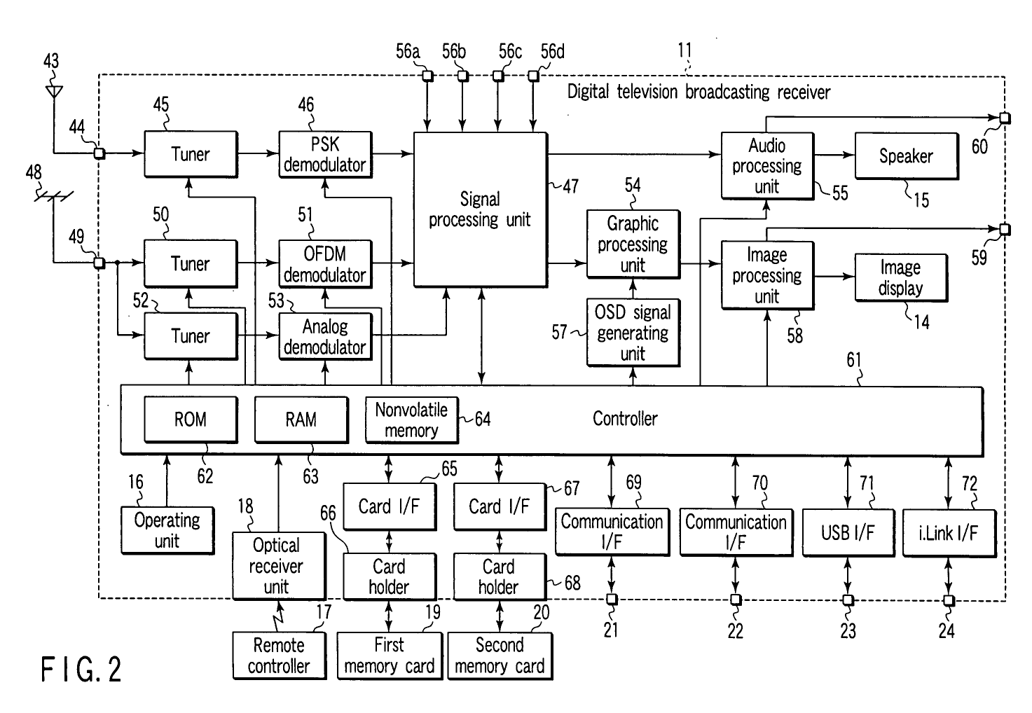

FIG. 2 shows a main signal processing system of the digital television broadcasting receiver 11 described above. Namely, by supplying satellite digital television broadcast signals received at an antenna 43 for receiving BS/CS digital broadcasting to a tuner 45 for satellite digital broadcasting via an input terminal 44, a broadcast signal of a desired channel is tuned.

Then, the broadcast signal tuned by the tuner 45 is supplied to a phase shift keying (PSK) demodulator 46, and is demodulated into digital image signal and audio signal, and thereafter, the signal is outputted to a signal processing unit 47.

Further, by supplying terrestrial digital television broadcast signals received at an antenna 48 for receiving terrestrial broadcasting to a tuner 50 for terrestrial digital broadcasting via an input terminal 49, a broadcast signal on a desired channel is tuned.

Then, the broadcast signal tuned by the tuner 50 is supplied to an orthogonal frequency division multiplexing (OFDM) demodulator 51, and is demodulated into digital image signal and audio signal, and thereafter, the signal is outputted to the signal processing unit 47.

Further, by supplying terrestrial analog television broadcast signals received at the antenna 48 for receiving terrestrial broadcasting to a tuner 52 for terrestrial analog broadcasting via the input terminal 49, a broadcast signal on a desired channel is tuned. Then, the broadcast signal tuned by the tuner 52 is supplied to an analog demodulator 53, and is demodulated into analog image signal and audio signal, and thereafter, the signal is outputted to the signal processing unit 47.

Here, the signal processing unit 47 selectively applies predetermined digital signal processing onto digital image signals and audio signals respectively supplied from the PSK demodulator 46 and the OFDM demodulator 51, and outputs those to a graphic processing unit 54 and an audio processing unit 55.

Further, a plurality (in the case of the illustration, four) of input terminals 56a, 56b, 56c, and 56d are connected to the signal processing unit 47. The input terminals 56a to 56d respectively enable analog image signals and audio signals to be inputted from the exterior of the digital television broadcast signal receiving apparatus 11.

Then, the signal processing unit 47 selectively digitizes analog image signals and audio signals respectively supplied from the analog demodulator 53 and the respective input terminals 56a to 56d, and applies predetermined digital signal processing onto the digitized image signals and audio signals, and thereafter, the signal processing unit 47 outputs those to the graphic processing unit 54 and the audio processing unit 55.

Among those, the graphic processing unit 54 has a function of superimposing an OSD signal generated at an on-screen display (OSD) signal generating unit 57 onto a digital image signal supplied from the signal processing unit 47 to be outputted. The graphic processing unit 54 can selectively output an output image signal from the signal processing unit 47 and an output OSD signal from the OSD signal generating unit 57, and can output both outputs in a combination so as to respectively configure the halves of the screen.

A digital image signal outputted from the graphic processing unit 54 is supplied to the image processing unit 58. The image processing unit 58 converts the input digital image signal into an analog image signal in a format which can be displayed on the image display 14, and thereafter, the image processing unit 58 outputs the analog image signal to be not only displayed on the image display 14, but also delivered to the exterior via an output terminal 59.

Further, the audio processing unit 55 converts the input digital audio signal into an analog audio signal in a format which can be played back, and thereafter, the audio processing unit 55 outputs the analog audio signal to the speakers 15 to be not only played back, but also delivered to the exterior via an output terminal 60.

Here, with respect to the digital television broadcasting receiver 11, all the operations including various receiving operations described above are overall controlled by a control unit 61. The control unit 61 has a built-in central processing unit (CPU) and the like, receives operational information from the operating unit 16, or receives operational information transmitted from the remote controller 17 via the optical receiver unit 18, and respectively controls the respective portions so as to reflect the operational contents.

In this case, the control unit 61 mainly utilizes a read only memory (ROM) 62 in which a control program executed by the CPU has been stored, a random access memory (RAM) 63 for providing a work area to the CPU, and a nonvolatile memory 64 in which various setting information, control information, and the like are stored.

Further, the control unit 61 is connected to a card holder 66 to which the first memory card 19 can be mounted via a card I/F (interface) 65. Consequently, the control unit 61 can carry out information transmission via the first memory card 19 mounted to the card holder 66, and the card I/F 65.

Moreover, the control unit 61 is connected to a card holder 68 to which the second memory card 20 can be mounted via a card I/F (interface) 67. Consequently, the control unit 61 can carry out information transmission via the second memory card 20 mounted to the card holder 68, and the card I/F 67.

Further, the control unit 61 is connected to the first LAN terminal 21 via a communication I/F 69. Accordingly, the control unit 61 can carry out information transmission via the LAN compatible HDD 25 connected to the first LAN terminal 21, and the communication I/F 69. In this case, the control unit 61 has a DHCP (dynamic host configuration protocol) server function, and controls so as to allocate an IP (internet protocol) address to the LAN compatible HDD 25 connected to the first LAN terminal 21.

Moreover, the control unit 61 is connected to the second LAN terminal 22 via a communication I/F 70. Accordingly, the control unit 61 can carry out information transmission via the various devices (refer to FIG. 1) connected to the second LAN terminal 22, and the communication I/F 70.

Further, the control unit 61 is connected to the USB terminal 23 via a USB I/F 71. Accordingly, the control unit 61 can carry out information transmission via the various devices (refer to FIG. 1) connected to the USB terminal 23, and the communication I/F 71.

Moreover, the control unit 61 is connected to the i.Link terminal 24 via an i.Link I/F 72. Consequently, the control unit 61 can carry out information transmission via the various devices (refer to FIG. 1) connected to the i.Link terminal 24, and the i.Link I/F 72.

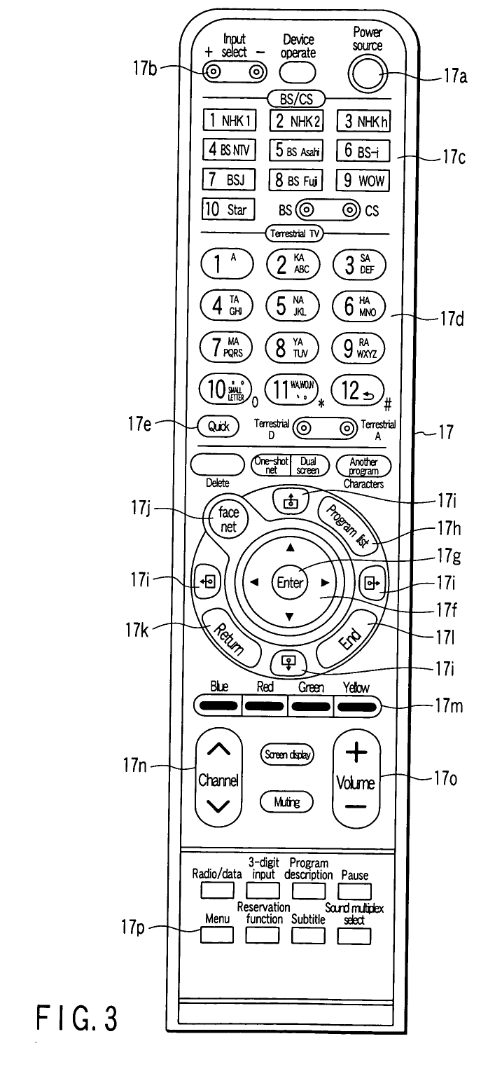

FIG. 3 shows an appearance of the remote controller 17. A power source key 17a, an input switching key 17b, satellite digital broadcasting channel direct selection keys 17c, terrestrial broadcasting channel direct selection keys 17d, a quick key 17e, a cursor key 17f, an enter key 17g, a program list key 17h, page switching keys 17i, a face net (navigation) key 17j, a return key 17k, an end key 171, blue, red, green, and yellow color keys 17m, a channel up/down key 17n, a volume control key 17o, a menu key 17p, and the like are provided to the remote controller 17.

Here, reservation functions which the digital television broadcasting receiver 11 described above has will be described. As the reservation functions, there are two types of a program designating reservation for carrying out a reservation by designating a program which has been scheduled to be broadcast, and a date and time designating reservation for carrying out a reservation by designating a channel and a date and time.

Further, as the program designating reservation, there are a recording reservation in which a designated program is recorded in a recording device or on a recording medium such as a memory card, and a viewing reservation in which only a selection of a designated program is carried out. Moreover, as the date and time designating reservation, there are a recording reservation in which contents on designated channel and date and time is recorded in a recording device or on a recording medium such as a memory card, and a viewing reservation in which only a selection of broadcasting on designated channel and date and time is carried out.

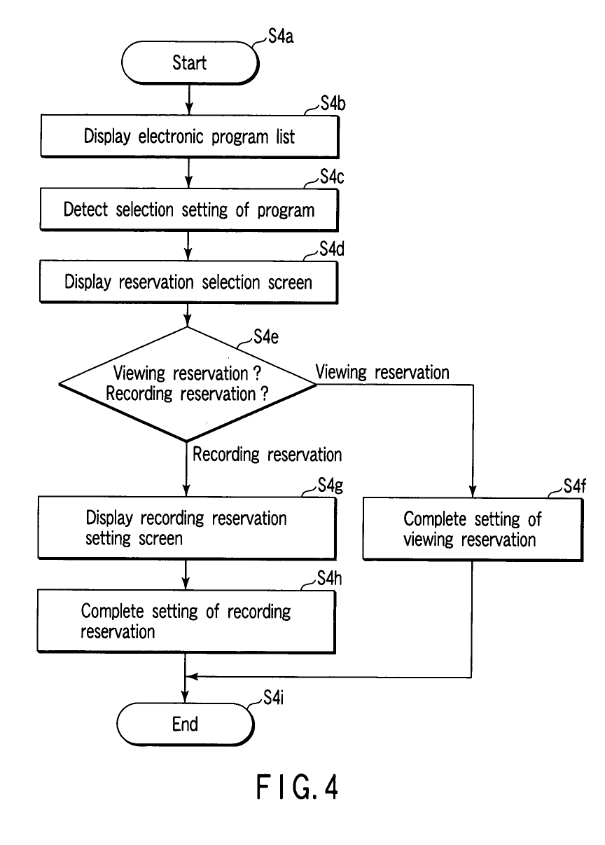

FIG. 4 shows a flowchart for explaining operations for setting a program designating reservation with respect to the digital television broadcasting receiver 11. The operation is started (step S4a) due to a user operating the program list key 17h of the remote controller 17.

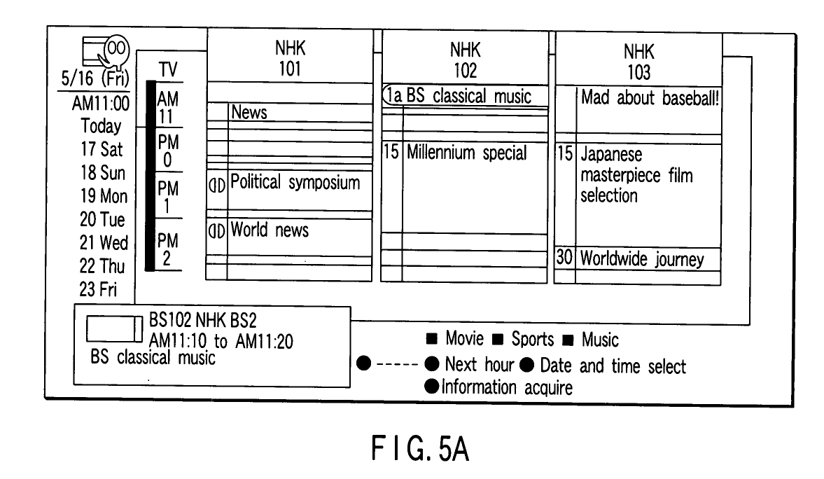

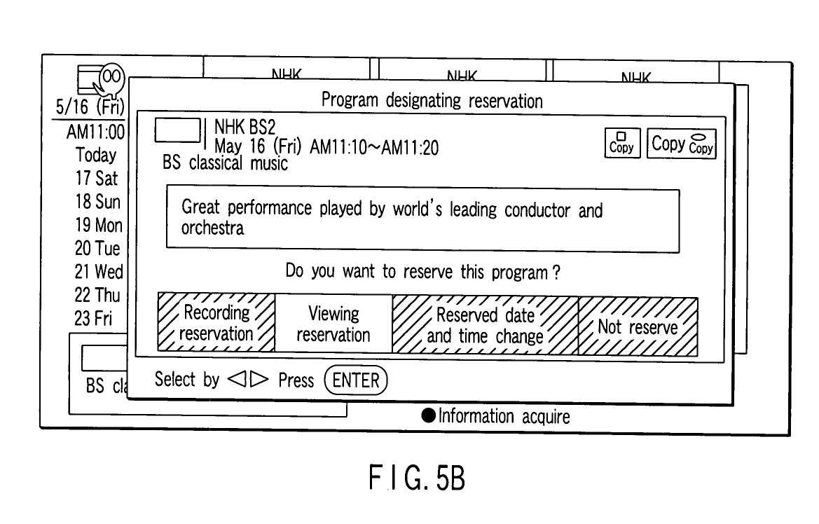

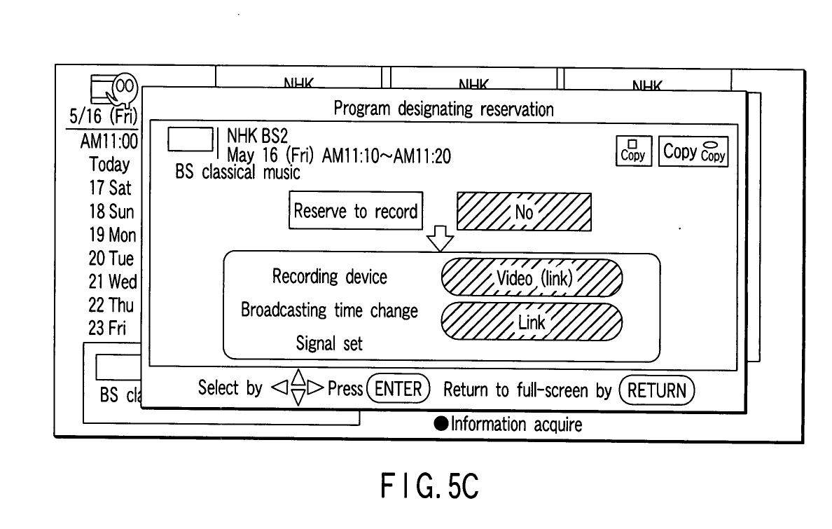

Then, the control unit 61 displays an electronic program list as shown in FIG. 5A on the image display 14 on the basis of electronic program guide (EPG) information which has been acquired in advance from a broadcast signal in step S4b.

In this manner, the user can select to set a desired program from the electronic program list. The selection setting is executed by operating the enter key 17g after selecting a desired program by operating the cursor key 17f of the remote controller 17.

Therefore, when the control unit 61 detects that a desired program has been selected to set from the electronic program list, the control unit 61 displays a reservation selection screen as shown in FIG. 5B in step S4d.

On this reservation selection screen, a broadcasting channel, a broadcasting date, a summary description on contents, and the like which correspond to the program which has been selected to set are displayed, and it is possible for a user to select a recording reservation or a viewing reservation. This selection is executed by operating the enter key 17g after selecting a recording reservation or a viewing reservation by operating the cursor key 17f of the remote controller 17.

Then, the control unit 61 determines whether a recording reservation or a viewing reservation has been selected in step S4e. When it is determined that a viewing reservation has been selected, the viewing reservation setting is completed by storing the various information set for the viewing reservation in the nonvolatile memory 64 in step S4f, and the processing is terminated (step S4i). By setting a viewing reservation in this way, a selected program is automatically tuned, and is provided for being viewed.

Further, when it is determined that a recording reservation has been selected in the step S4e, the control unit 61 displays a recording reservation setting screen as shown in FIG. 5C in step S4g. On the recording reservation setting screen, it is possible to select whether or not the program which has been selected to set is reserved to be recorded, or to designate a digital recording device or a recording medium on which recording is to be carried out.

Then, when a recording reservation is required and various necessary items are set on the recording reservation setting screen, the control unit 61 completes the recording reservation setting by storing the various information set for the recording reservation in the nonvolatile memory 64 in step S4h, and terminates the processing (step S4i). By setting a recording reservation in this way, a selected program is automatically recorded on a designated digital recording device or recording medium.

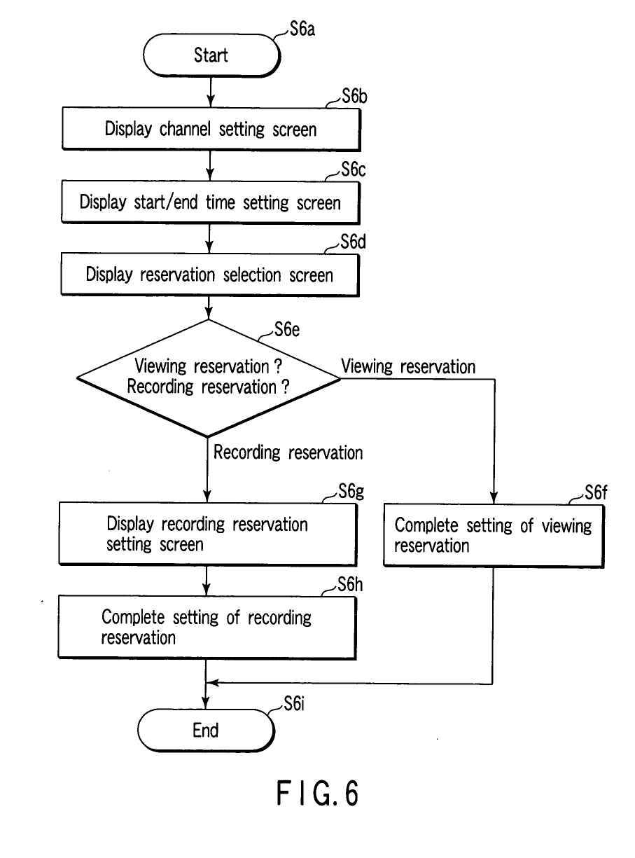

FIG. 6 shows a flowchart for explaining operations for setting a date and time designating reservation with respect to the digital television broadcasting receiver 11. The operation is started (step S6a) due to a user setting items of a date and time designating reservation from the hierarchy of a setting menu displayed on the image display 14 by operating the menu key 17p of the remote controller 17.

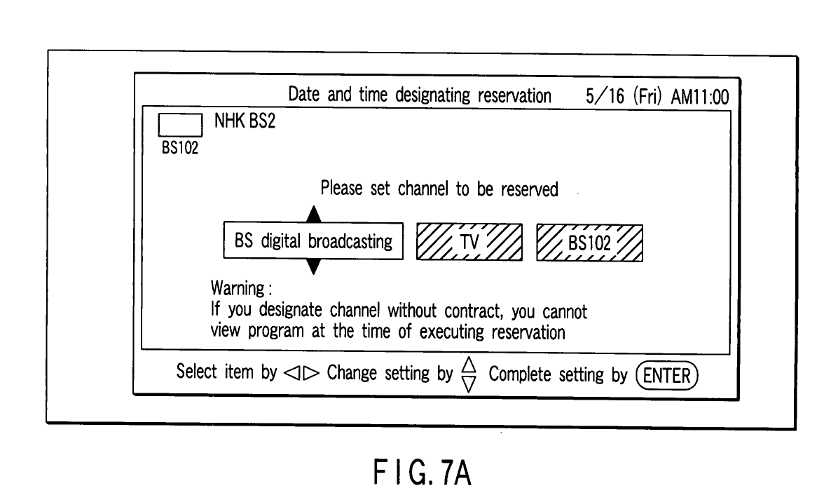

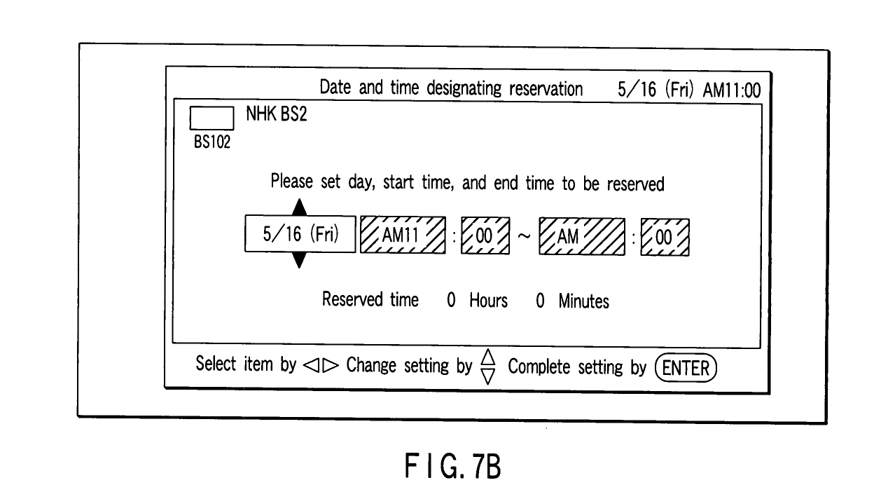

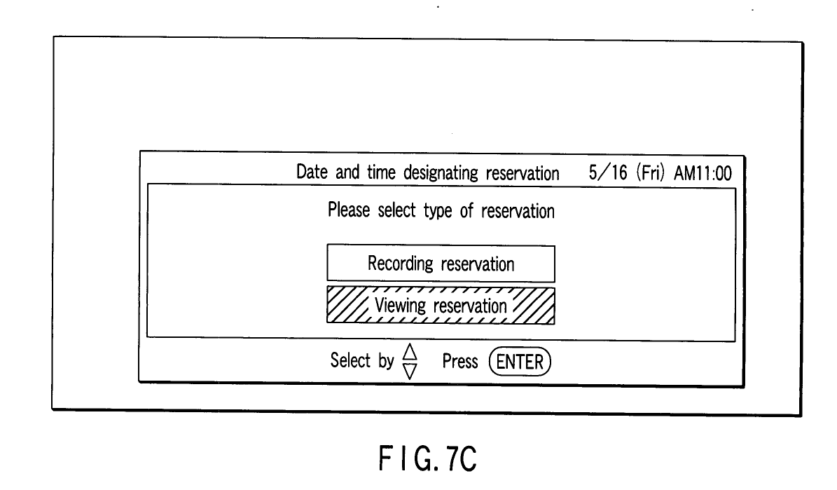

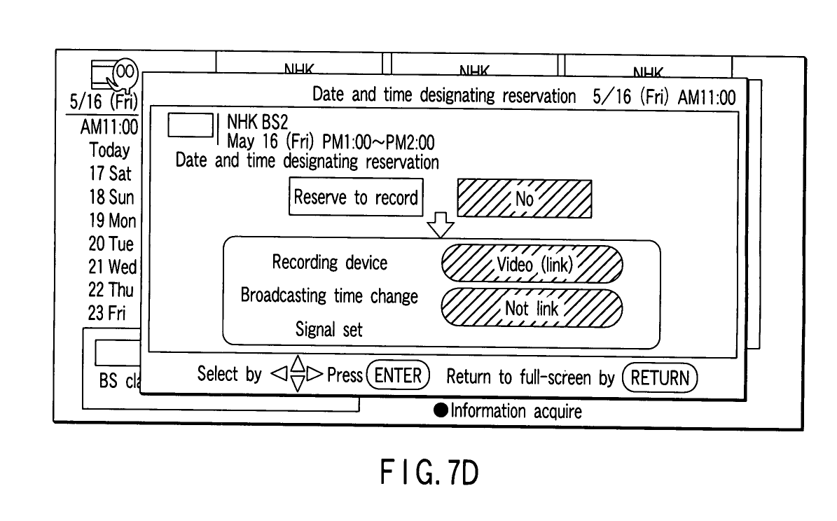

Then, the control unit 61 displays a channel setting screen as shown in FIG. 7A in step S6b. On the channel setting screen, channels belonging to BS digital broadcasting channels and 110 CS digital broadcasting can be set.

Then, when the control unit 61 detects that a channel is set on the channel setting screen, the control unit 61 displays a start/end time setting screen as shown in FIG. 7B in step S6c. On the start/end time setting screen, a day, a start time, and an end time to be reserved can be set.

Thereafter, when the control unit 61 detects that necessary items have been set on the start/end time setting screen, the control unit 61 displays a reservation selection screen as shown in FIG. 7C in step S6d. On the reservation selection screen, it is possible for a user to select a recording reservation or a viewing reservation.

Then, the control unit 61 determines whether a recording reservation or a viewing reservation has been selected in step S6e. When it is determined that a viewing reservation has been selected, the control unit 61 completes the viewing reservation setting by storing the various information set for the viewing reservation in the nonvolatile memory 64 in step S6f, and terminates the processing (step S6i). By setting a viewing reservation in this way, a broadcast on designated channel and date and time is automatically tuned, and is provided for being viewed.

Further, when it is determined that a recording reservation has been selected in step S6e, the control unit 61 displays a recording reservation setting screen as shown in FIG. 7D in step S6g. On the recording reservation setting screen, it is possible to select whether or not recording is reserved, or to designate a digital recording device or a recording medium on which recording is to be carried out.

Then, when a recording reservation is required and various necessary items are set on the recording reservation setting screen, the control unit 61 completes the recording reservation setting by storing the various information set for the recording reservation in the nonvolatile memory 64 in step S6h, and terminates the processing (step S6i). By setting a recording reservation in this way, a broadcast on designated channel and date and time is automatically recorded on a designated digital recording device or recording medium.

Further, the digital television broadcasting receiver 11 has a viewing program recording function by which it is possible to record a program which is currently being viewed until the end time so as to designate a recording device or a recording medium.

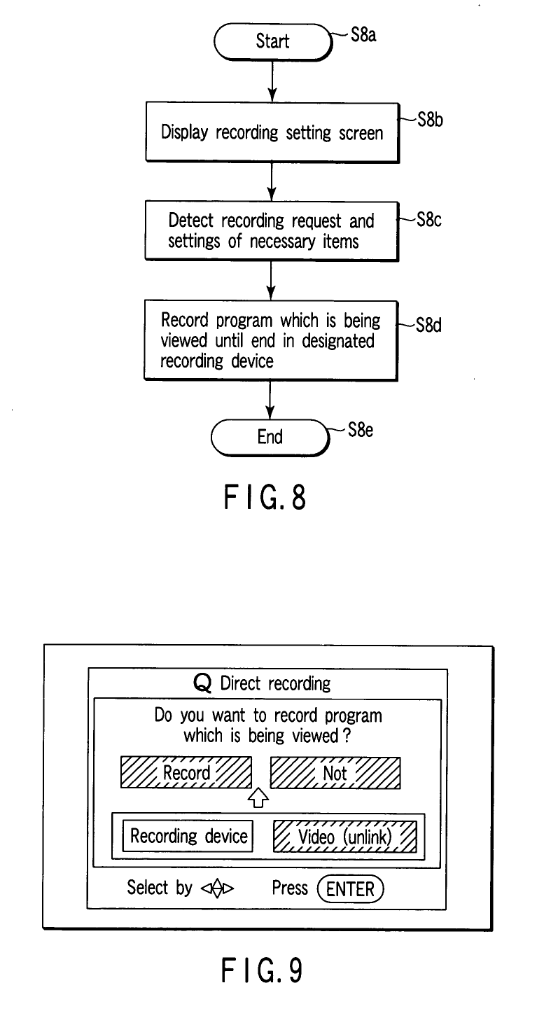

FIG. 8 shows a flowchart for explaining recording operations by the viewing program recording function. The operation is started (step S8a) due to a user selecting to set items of viewing program recording from a quick menu displayed on the image display 14 by operating the quick key 17e of the remote controller 17.

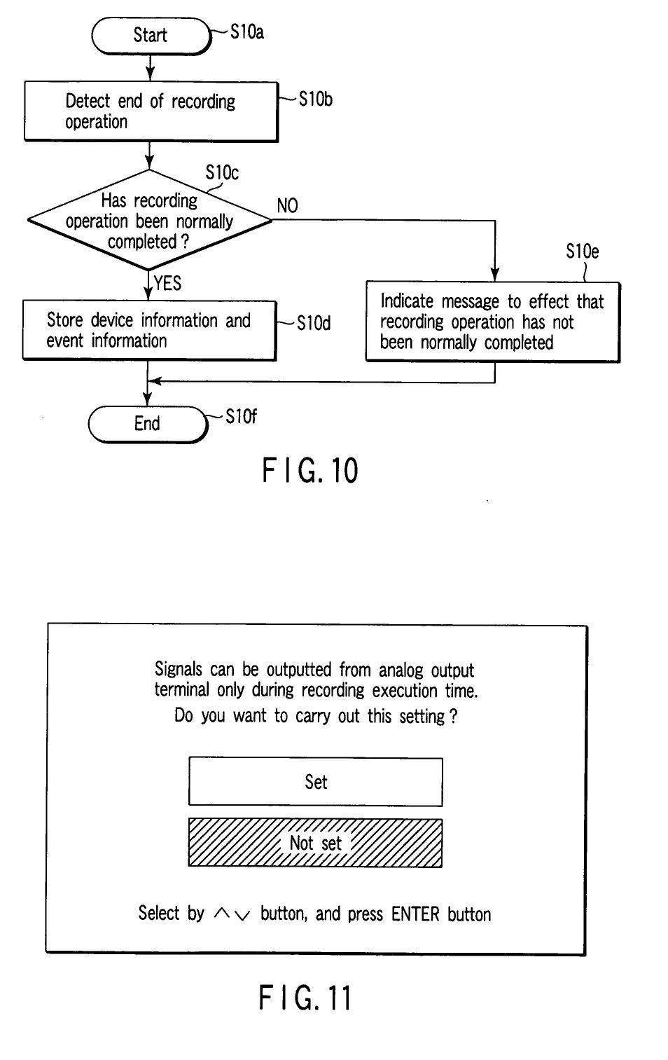

Then, the control unit 61 displays a recording setting screen as shown in FIG. 9 on the image display 14 in step S8b. On the recording setting screen, it is possible to select whether or not recording is carried out, or to designate a digital recording device or a recording medium on which recording is to be carried out.

Then, when the control unit 61 detects that a recording has been required, and various necessary items have been set on the recording setting screen in step S8c, the control unit 61 causes a designated digital recording device or recording medium to record a currently tuned program until the end time, and terminates the processing (step S8e).

By the recording reservation function and the viewing program recording function described above, it is possible for a user to record programs by arbitrarily selecting a plurality of digital recording devices connected to the respective terminals 21 to 24 of the digital television broadcasting receiver 11, or the first memory card 19 mounted to the card holder 66, and the like.

FIG. 10 shows a flowchart for explaining operations after recording has been executed by the recording reservation function and the viewing program recording function described above. Namely, when the operation is started (step S10a), the control unit 61 detects that the recording operation has been completed, and determines whether or not the recording operation has been normally completed in step S10c.

Then, when it is determined that the recording operation has been normally completed (YES), device information (a device ID, a device name, a shared folder name, and the like) for specifying a digital recording device or a recording medium on which recording has been carried out, and event information (an event ID, a channel number, a title, a contents description, a genre, a recording range, an picture quality mode, and the like) on the recorded program are stored in the nonvolatile memory 64 in step S10d, and the processing is terminated (step S10f).

Further, when it is determined that the recording operation has not been normally completed in the step S10c (NO), the control unit 56 indicates a message to the effect that the recording operation has not been normally completed on the image display 14, and terminates the processing (step S10f).

Further, the digital television broadcasting receiver 11 can be set so as to output an analog image signal and an analog audio signal from output terminals 59 and 60 only when recording is being executed onto a designated digital recording device or recording medium.

This setting is executed by selecting an output setting screen as shown in FIG. 11 from the hierarchy of the setting menu displayed on the image display 14 through the operation of the menu key 17p of the remote controller 17, and by selecting the item of “set” on the output setting screen.

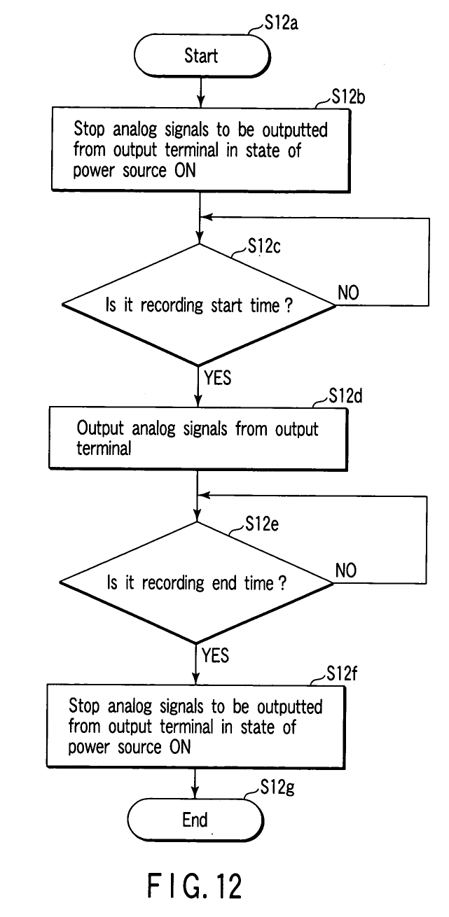

FIG. 12 shows a flowchart for explaining operations at the time of recording by a recording reservation function when the output setting described above has been carried out. When the operation is started (step S12a), the control unit 61 stops an analog image signal and an analog audio signal to be outputted from the output terminals 59 and 60 in a state in which the power source has been turned on, and one broadcast has been tuned to provide for being viewed, or the like in step S12b.

Then, the control unit 61 determines whether or not a recording start time in accordance with a recording reservation has come in step S12c. When it is determined that the recording start time has come (YES), the control unit 61 controls such that an analog image signal and an analog audio signal are outputted from the output terminals 59 and 60 in step S12d.

Thereafter, the control unit 61 determines whether or not a recording end time in accordance with a recording reservation has come in step S12e. When it is determined that the recording end time has come (YES), the control unit 61 stops an analog image signal and an analog audio signal to be outputted from the output terminals 59 and 60 again in a state of the power source ON in step S12f, and terminates the processing (step S12g).

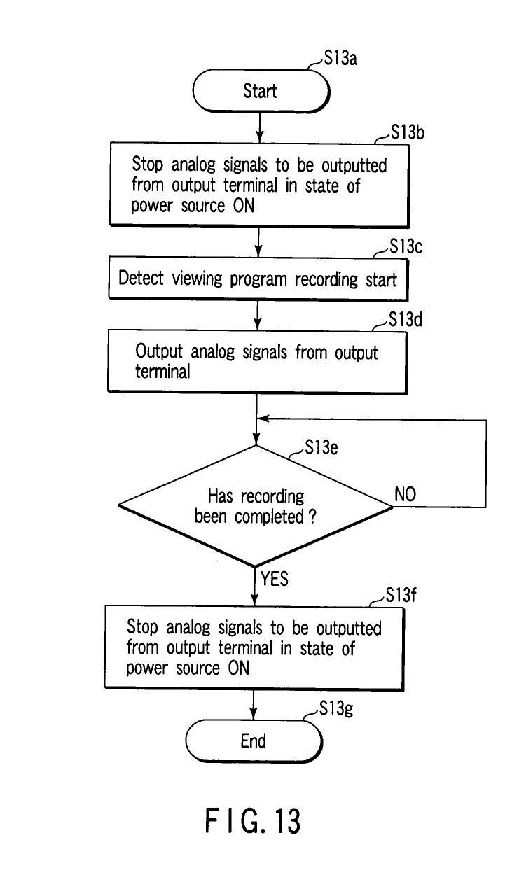

FIG. 13 shows a flowchart for explaining operations at the time of recording by a viewing program recording function when the output setting described above has been carried out. When the operation is started (step S13a), the control unit 61 stops an analog image signal and an analog audio signal to be outputted from the output terminals 59 and 60 in a state in which the power source has been turned on, and one broadcast has been tuned to provide for being viewed, or the like, in step S13b.

Then, when the control unit 61 detects that recording of the viewing program has been started, the control unit 61 controls such that an analog image signal and an analog audio signal are outputted from the output terminals 59 and 60 in step S13d.

Thereafter, the control unit 61 determines whether or not the recording has been terminated in step S13e. When it is determined that the recording has been terminated (YES), the control unit 61 stops an analog image signal and an analog audio signal to be outputted from the output terminals 59 and 60 in a state of the power source ON again in step S13f, and terminates the processing (step S13g).

Further, the digital television broadcasting receiver 11 has a recorded program searching function of searching a desired program from among various programs recorded on various digital recording devices or recording media by the recording reservation function and the viewing program recording function described above.

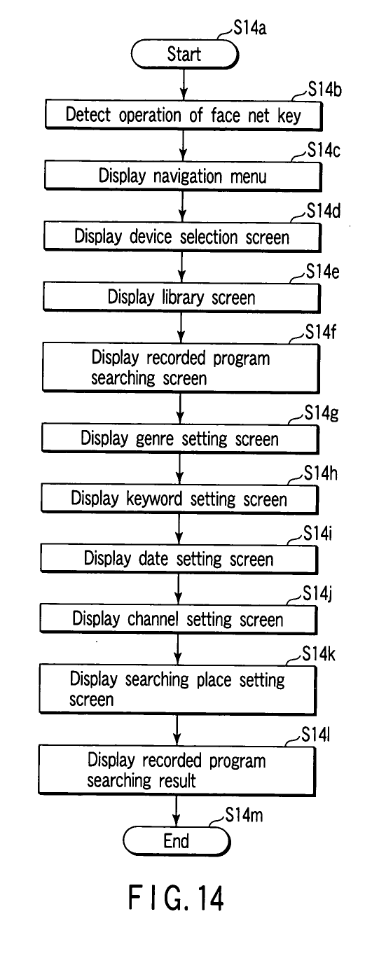

FIG. 14 shows a flowchart for explaining searching operations in accordance with the recorded program searching function. The operation is started by a user's operation of the face net key 17j of the remote controller 17.

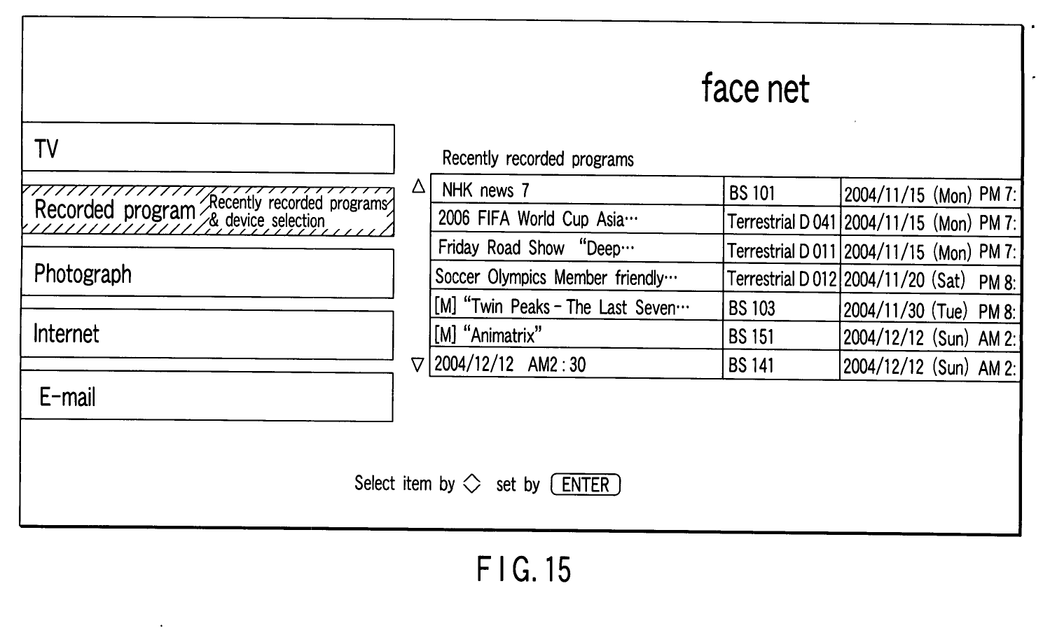

Namely, when the control unit 61 detects an operation of the face net key 17j in step S14b, the control unit 61 starts a face net (navigation) in step S14c, and a navigation screen as shown in FIG. 15 is displayed on the image display 14.

On the navigation screen, five items of “Television”, “Recorded program”, “Photograph”, “Internet”, and “E mail” are displayed so as to be selectable. This selection is executed by operating the enter key 17g after selecting a desired item by operating the cursor key 17f of the remote controller 17. A selected item is displayed so as to change the color differently from the other items on the screen. However, in FIG. 15, the state in which “Recorded program” has been selected is shown by hatching.

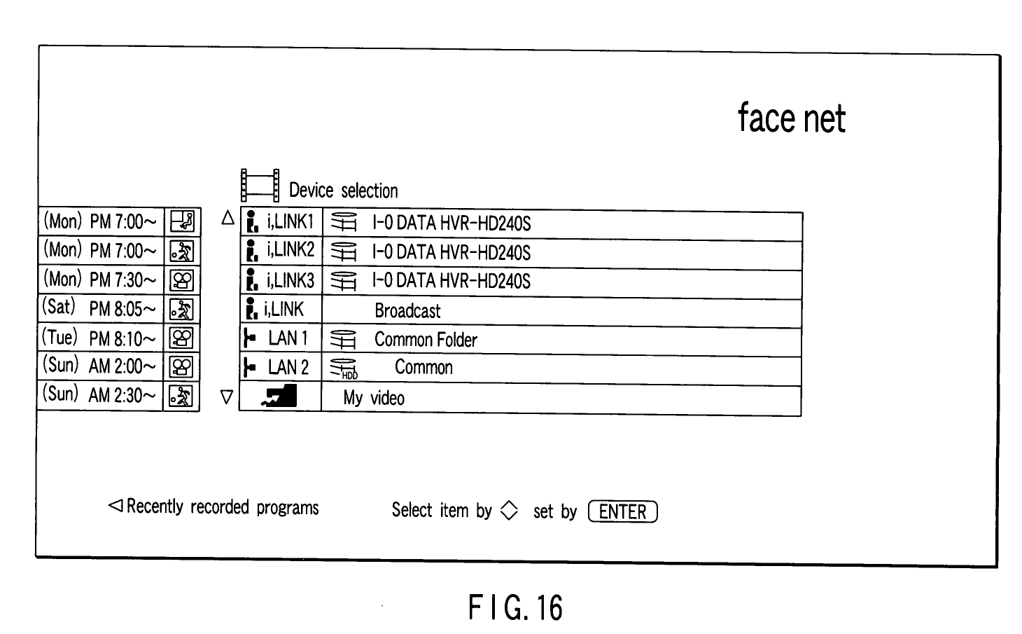

Here, when the user selects the item of “Recorded program”, and further selects to set the item of “Device selection” included therein, the control unit 61 displays a device selection screen as shown in FIG. 16 in step S14d.

On the device selection screen, various devices connected to the first and second LAN terminals 21 and 22, the USB terminal 23, and the i.Link terminal 24, or the memory cards 19 and 20 mounted to the card holders 66 and 68 are displayed in a list on the basis of the up-to-date information which the control unit 61 has recognized. Therefore, the user can select a desired device or memory card from the device selection screen.

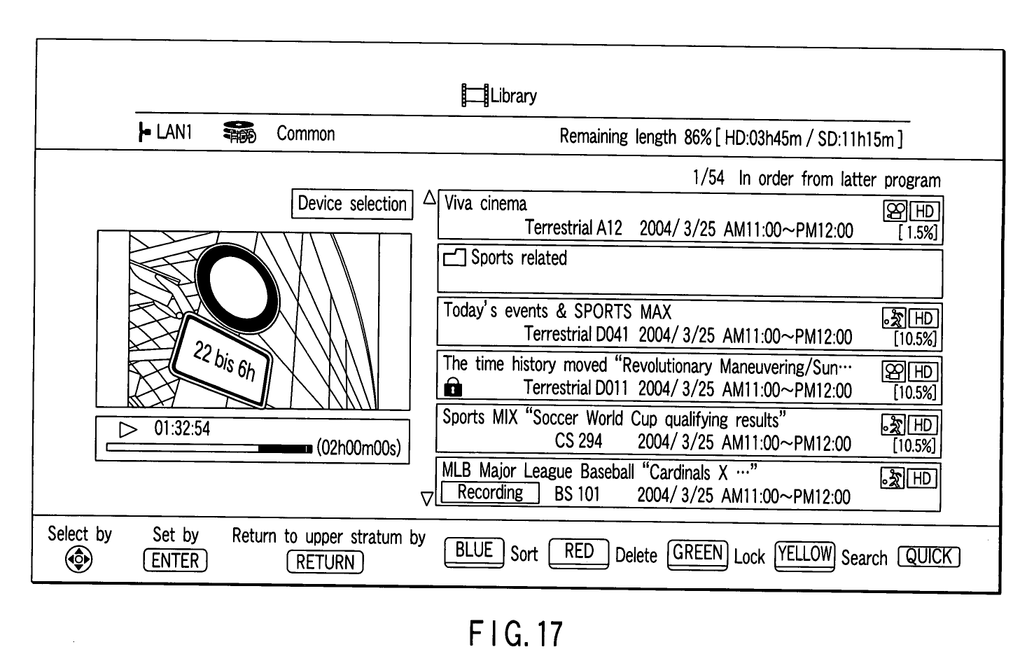

Then, the control unit 61 detects that a specific digital recording device (for example, the HDD 25 which is an NAS connected to the first LAN terminal 21) has been selected from the device selection screen, the control unit 61 accesses to the HDD 25 so as to display a library screen as shown in FIG. 17 in step S14e.

On the library screen, a list of all the programs recorded in the HDD 25 is displayed. In this case, a title, a channel, a recorded date and time, a genre, a picture quality, and the like are displayed with respect to each program. Further, on the library screen, a program which is currently being recorded can be displayed so as to be with an icon of “Recording”.

In a case of the library screen, programs up to six are displayed on one screen. However, when six programs or more have been recorded, all the programs can be displayed by scrolling the screen up and down by operating the cursor key 17f of the remote controller 17.

Note that, in the HDD 25, programs can be stored in folder formats. It is possible to hierarchically manage recorded programs such that, for example, a folder of “Sports related” is prepared, folders such as “The Olympics” and “Town athletic meet” are prepared under the folder, and folders such as “Marathon” and “Swimming” are further prepared under the folder of “The Olympics”. On the library screen shown in FIG. 17, in a case in which folders have been prepared, a folder at the top stage (“Sports related” in FIG. 17) is displayed.

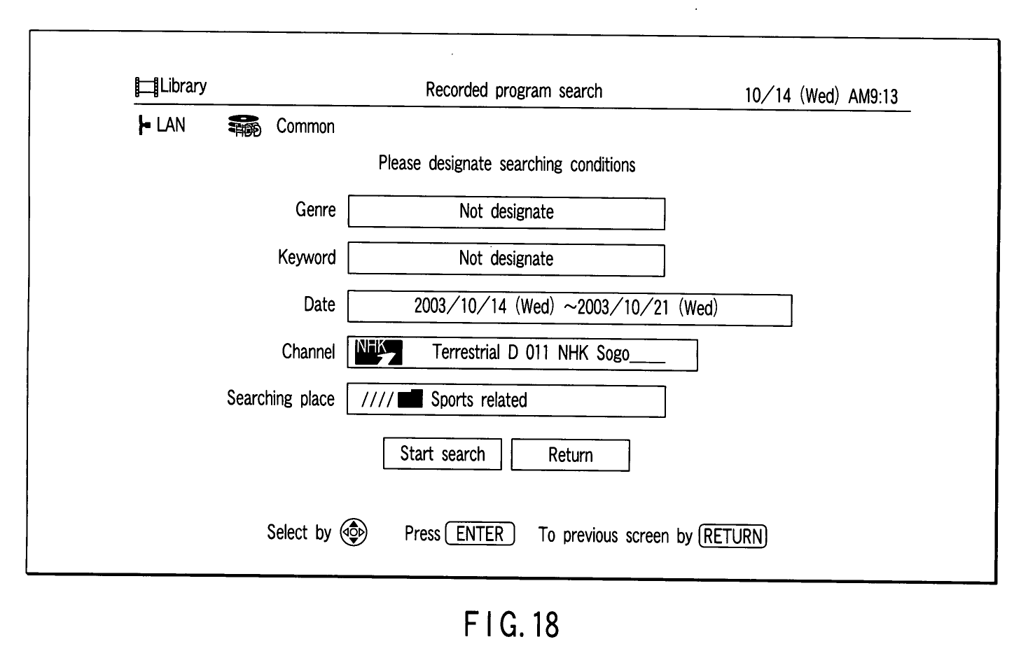

Then, when the control unit 61 detects that the yellow color key 17m of the remote controller 17 has been operated in a state of displaying the library screen, a recorded program searching screen as shown in FIG. 18 is displayed in step S14f.

On the recorded program searching screen, five searching conditions of “Genre”, “Keyword”, “Date”, “Channel”, and “Searching place” can be set. Then, the control unit 61 searches a program corresponding to at least one of the five searching conditions from among all the programs displayed on the library screen, i.e., all the programs recorded in the HDD 25.

Note that it is possible to set such that a program corresponding to a logical product or a logical sum of a combination of, not all of, but a plurality of types of the five searching conditions, i.e., two, three, or four of the five searching conditions. Further, it is possible to set so as to search a program corresponding to a logical product or a logical sum of all of the five searching conditions. Those settings are executed by an operation of the user.

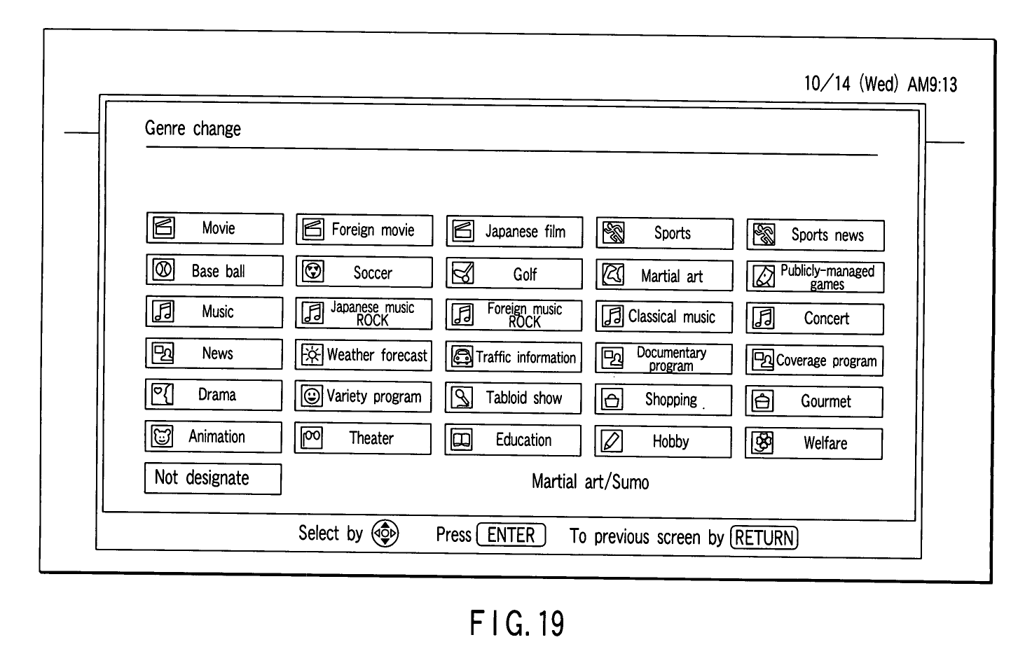

Namely, when the user selects “Genre” as a searching condition from the recorded program searching screen, the control unit 61 displays a genre setting screen as shown in FIG. 19 in step S14g.

On this genre setting screen, items denoting a plurality of genres such as “Movies”, “Foreign films”, “Japanese films” and “Sports” are displayed in a list. It is possible for the user to select an item corresponding to an arbitrary genre, and also to search a program corresponding to a set genre. Note that it is possible to not designate a genre as a searching condition by selecting an item of “Not designate”.

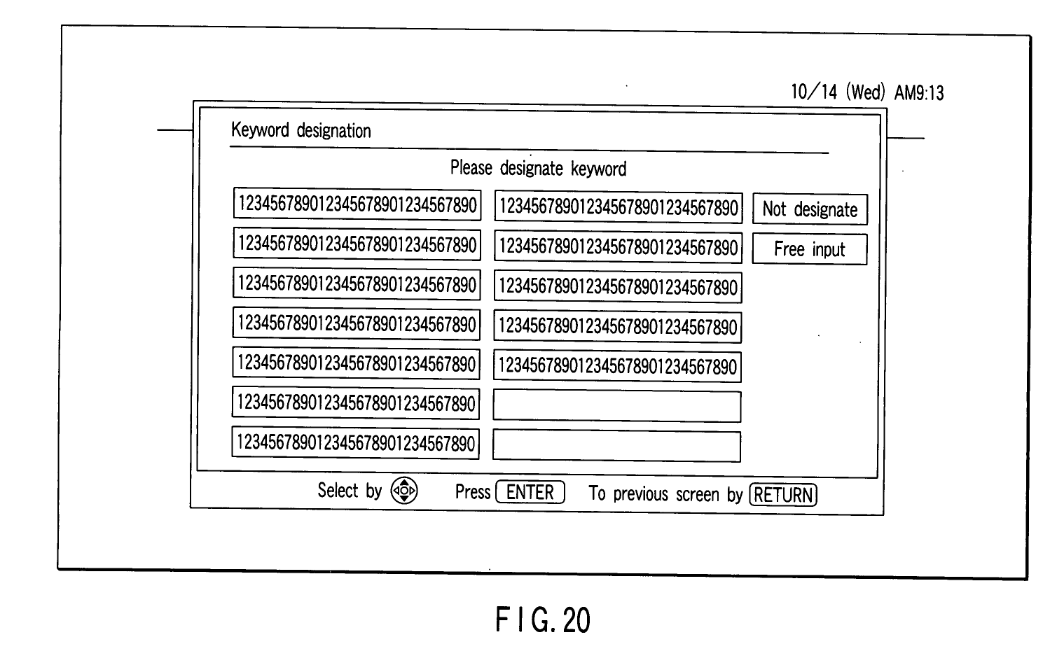

When the setting of a genre has been correctly completed, or when the return key 17k of the remote controller 17 has been operated, the routine returns to the recorded program searching screen shown in FIG. 18 again. Then, when the user selects “Keyword” as a searching condition from the recorded program searching screen, the control unit 61 displays a keyword setting screen as shown in FIG. 20 in step S14h.

On the keyword setting screen, the user can set keywords up to 14, and it is possible to search a program on the basis of, for example, a logical sum of the set keywords. Note that it is possible to not designate a keyword as a searching condition by selecting an item of “Not designate”.

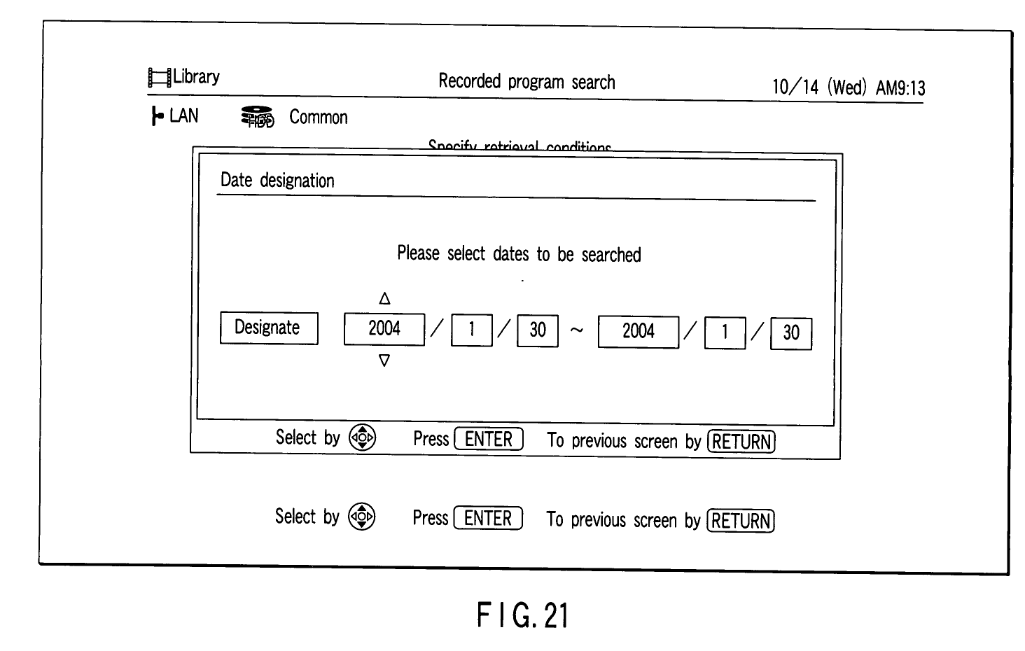

When the setting of a keyword has been correctly completed, or when the return key 17k of the remote controller 17 has been operated, the routine returns to the recorded program searching screen shown in FIG. 18 again. Then, when the user selects “Date” as a searching condition from the recorded program searching screen, the control unit 61 displays a date setting screen as shown in FIG. 21 in step S14i.

On the date setting screen, it is possible for the user to set a specific day or a period such as a period from XXXX year, XX month, XX day up to XXXX year, XX month, XX day, and it is possible to search a program recorded on a set day or in a set period.

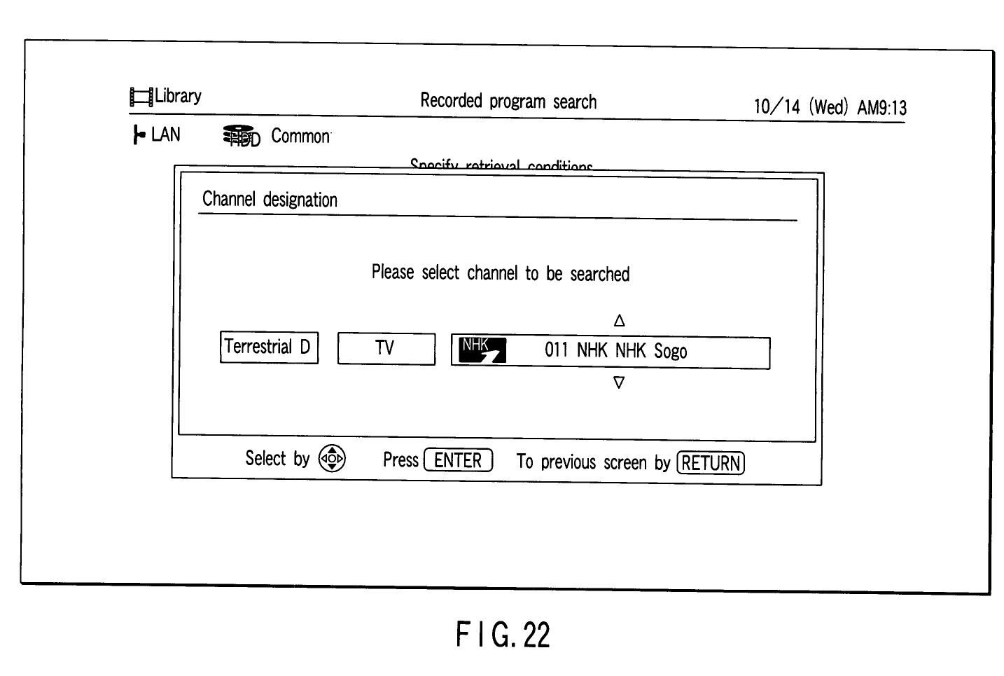

When the setting of a date has been correctly completed, or when the return key 17k of the remote controller 17 has been operated, the routine returns to the recorded program searching screen shown in FIG. 18 again. Then, when the user selects “Channel” as a searching condition from the recorded program searching screen, the control unit 61 displays a channel setting screen as shown in FIG. 22 in step S14j.

On the channel setting screen, it is possible to set a channel for each format of a broadcast such as terrestrial digital broadcasting and the like, and it is also possible to search a program recorded on a set channel.

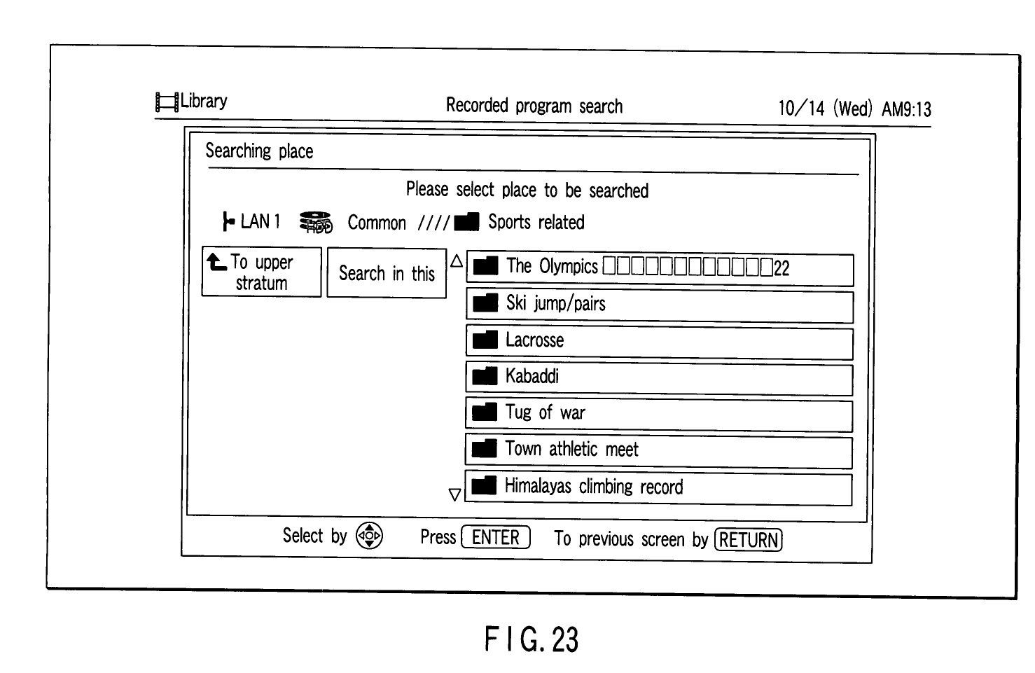

When the setting of a channel has been correctly completed, or when the return key 17k of the remote controller 17 has been operated, the routine returns to the recorded program searching screen shown in FIG. 18 again. Then, when the user selects “Searching place” as a searching condition from the recorded program searching screen, the control unit 61 displays a searching place setting screen as shown in FIG. 23 in step S14k.

On the searching place setting screen, it is possible to set a searching place for designating a folder in which a program search will be carried out independently of the hierarchy, and it is possible to search a program with the above-described genre, keyword, date, and channel being as conditions in one or a plurality of folders which have been set.

When the setting of a searching place has been correctly completed, or when the return key 17k of the remote controller 17 has been operated, the routine returns to the recorded program searching screen shown in FIG. 18 again.

As described above, the five searching conditions can be respectively set. As the five searching conditions, there is no need to set those in order of a genre, a keyword, a date, a channel, and a searching place as described above, and it is possible to set those in order from any condition.

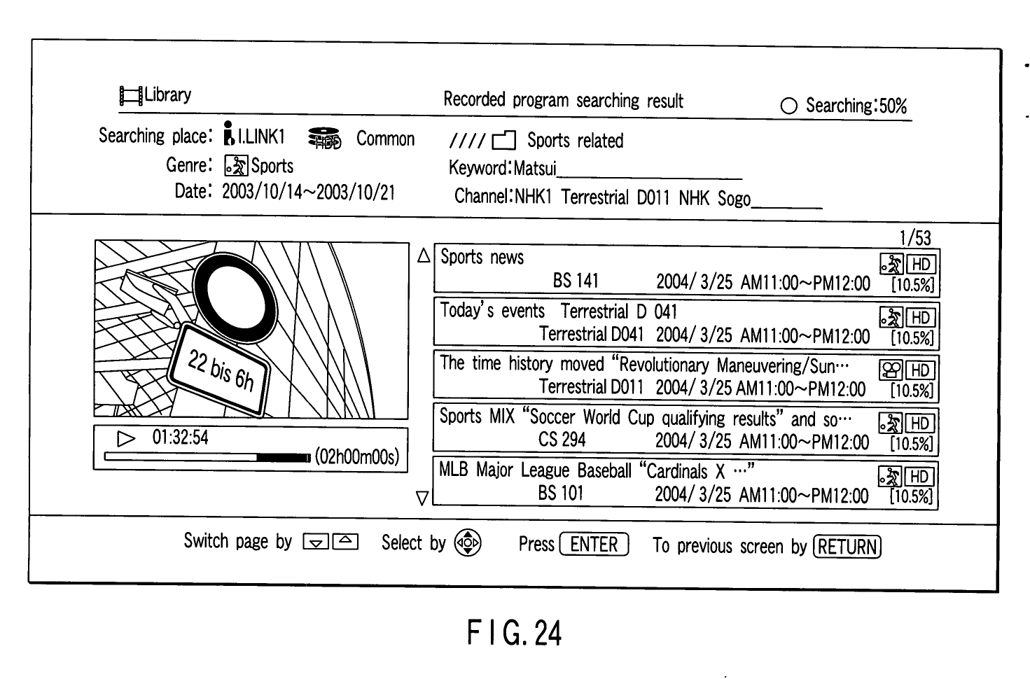

When the user selects an item of “Searching start” from the recorded program searching screen in a state in which the five searching conditions have been set in this way, the control unit 61 executes a program search on the basis of the five searching conditions with respect to all the programs recorded in the HDD 25 in step S141. This program search is realized by accessing to the HDD 25. Then, when the program search is terminated, the control unit 61 displays a screen of a recorded program searching result as shown in FIG. 24, and terminates the processing (step S14m).

On the screen of the recorded program searching result, a list of programs searched on the basis of a designated digital recording device or recording medium (in this case, the HDD 25), and the five searching conditions are displayed.

Here, the digital television broadcasting receiver 11 has a function in which a desired program is selected by operating the cursor key 17f of the remote controller 17 from the screen of the recorded program searching result displayed in the way described above, and the program can be played back by operating the enter key 17g.

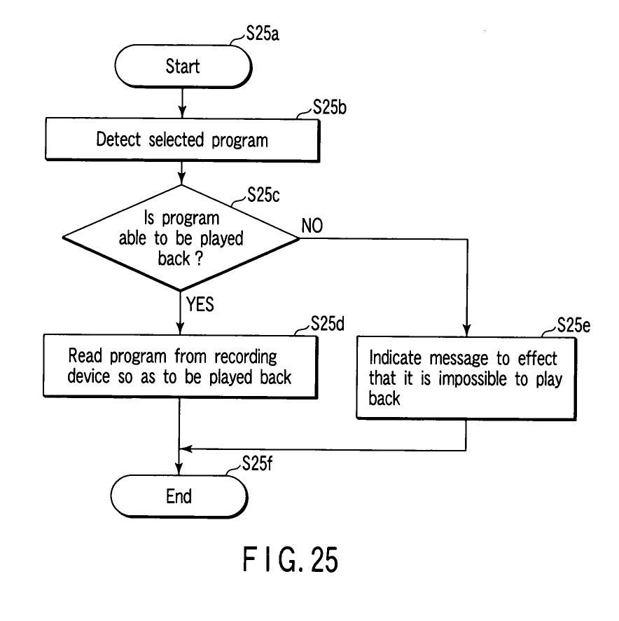

FIG. 25 shows a flowchart for explaining operations for playing back a selected program. Namely, when the operation is started (step S25a), the control unit 61 detects a selected program from the screen of the recorded program searching result in step S25b, and determines whether or not the program can be played back from the digital recording device having the selected program recorded therein in step S25c.

The determination includes, for example, a determination of whether or not a format of a recorded program corresponds to an image display in the digital television broadcasting receiver 11, and a determination of whether or not a file of a recorded program file has been broken.

Then, when it is determined that the program can be played back in the step S25c (YES), the control unit 61 controls to read information on the program requested to be played back from the digital recording device to be object to be played back in step S25d, and terminates the processing (step S24f).

Further, when it is determined that the program cannot be played back in the step S25c (NO), the control unit 61 indicates a message to the effect that it is impossible to play back the program requested on the image display 14 in step S25e, and terminates the processing (step S25f).

In accordance with the embodiment described above, by designating a connected digital recording device or a recording medium such as a memory card, and by setting searching conditions such as a genre, a keyword, a date, a channel or a searching place, it is possible to search a recorded program corresponding to a searching condition from the designated recording device or recording medium. Therefore, it is possible to rapidly search a desired recorded program from a plurality of recording devices or recording media connected to a network.

Further, in the embodiment described above, a specific recording device or recording medium is designated from a plurality of recording devices or recording media connected to a network, and a program is searched on the basis of searching conditions from the designated recording device or recording medium. However, the present invention is not limited thereto, and for example, it is possible that a server which unifies management of all of the recording devices or recording media is configured on the network, and a program search on the basis of a searching condition can be carried out with all the connected recording devices or recording media being as objects.

Note that, the present invention is not limited to the above embodiment as is, but can be modified and embodied in various ways within a range which does not deviate from the gist of the invention at the stage of implementing the invention. Further, various inventions can be formed by appropriately combining a plurality of structural requirements disclosed in the above embodiment. For example, some of the structural requirements may be omitted from all of the structural requirements shown in the embodiment. Moreover, structural requirements relating to different embodiments may be appropriately combined.

What is claimed is:

1. A recorded program searching apparatus comprising:
connection units configured to connect to a plurality of recording units;
a selection unit configured to select a predetermined recording unit from said plurality of recording units connected to the connection units;
a setting unit configured to set a plurality of types of searching conditions for searching a recorded program from the recording unit selected at the selection unit; and
a searching unit configured to carry out a program search on the basis of said plurality of types of searching conditions set at the setting unit from among programs recorded in the recording unit selected at the selection unit.

2. A recorded program searching apparatus according to claim 1, wherein
the searching unit is configured to search a program corresponding to at least one of said plurality of types of searching conditions set at the setting unit.

3. A recorded program searching apparatus according to claim 1, wherein
the searching unit is configured to search a program corresponding to combinations of, not all of, but a plurality of types among said plurality of types of searching conditions set at the setting unit.

4. A recorded program searching apparatus according to claim 1, wherein
the searching unit is configured to search a program corresponding to combinations of all said plurality of types of searching conditions set at the setting unit.

5. A recorded program searching apparatus according to claim 1, wherein
the setting unit is configured to set one of a genre, a keyword, a date, and a channel as said plurality of types of searching conditions.

6. A recorded program searching apparatus according to claim 1, wherein
the searching unit is configured to carry out a program search on the basis of said plurality of types of searching conditions set at the setting unit by accessing to the recording unit selected at the selection unit.

7. A recorded program searching apparatus according to claim 6, further comprising
a display unit configured to carry out a display of recorded programs in a list with respect to the recording unit selected at the selection unit.

8. A recorded program searching apparatus according to claim 7, wherein
the display unit is configured to add a folder at the top stage to the display of recorded programs in a list when the programs have been stored in a hierarchical structure of folders in the recording unit selected at the selection unit.

9. A recorded program searching apparatus according to claim 8, wherein
the setting unit is configured to set a searching place for designating a folder in which a program search is to be carried out, as a searching condition.

10. A recorded program searching apparatus according to claim 6, further comprising:
a searching program selection unit configured to select a predetermined program from the programs searched at the searching unit; and
a playback unit configured to read the program selected by the searching program selection unit from the recording unit so as to be played back.

11. A recorded program searching apparatus according to claim 1, wherein
the recording unit includes one of a recording device and a recording medium on which a program is recorded.

12. A recorded program searching method comprising:
a first step of connecting a plurality of recording units;
a second step of selecting a predetermined recording unit from said plurality of recording units connected in the first step;
a third step of setting a plurality of types of searching conditions for searching a recorded program from the recording unit selected in the second step; and
a fourth step of carrying out a program search on the basis of said plurality of types of searching conditions set in the third step from the recording unit selected in the second step.

13. A recorded program searching method according to claim 12, further comprising:
a fifth step of selecting a predetermined program from among programs searched in the fourth step, and
a sixth step of reading the program selected in the fifth step from the recording unit so as to be played back.
